(19) United States
(12) Patent Application Publication
(10) Pub. No.: US 2002/0134888 A1
(43) Pub. Date: Sep. 26, 2002

(54) Variable airfoil wing

(76) Inventor: Allison Earl Hall, Houston, TX (US)

Correspondence Address: DELPHINE M. JAMES, 2656 SOUTH LOOP WEST #170, HOUSTON, TX, 77054, US

(21) Appl. No.: 09/816,185

(22) Filed: Mar. 26, 2001

(51) Int. Cl. B64C 1/00; B64C 3/00; B64C 5/00

(52) U.S. Cl. 244/124

(57) ABSTRACT

The invention lies in the field of fluid dynamics. In particular, the invention pertains to aircraft airfoils and wing designs. The variable airfoil wing is a simple concept which divides an aircraft wing into a forward segment and a rearward segment. The wing forward segment is fixed and the wing rearward segment is movable. Using a symmetrical airfoil design as the base wing shape, the rearward segment is rotated downward to increase the wing camber. When utilized in accordance with specific limitations, the wing design offers a broad range of aerodynamic capabilities.

### BACKGROUND OF THE INVENTION

The invention lies in the field of fluid dynamics. In particular, the invention pertains to airfoil and wing designs.

The primary aerodynamic principle utilized in aircraft is the effect of the dynamic pressure of air acting on the wing as it is being propelled through the air. The dynamic pressure is proportional to the relative speed between the air and the aircraft. Air resistance acting on aerodynamic shapes create drag, which is defined as the force counteracting the forward thrust force of the aircraft.

The shape of an aircraft wing, or airfoil, has undergone considerable change since flight was first achieved. Today most aircraft utilize an airfoil shape that has a convex curve on the top surface and a lesser convex curve on the bottom surface. The distance differential that the air must travel creates the force called lift. The greater the top surface curve and the lesser the bottom surface curve the greater the lift. However, increasing the curved surface also increases drag. The objective is to design a wing shape to minimize drag and to maximize lift.

### SUMMARY OF THE INVENTION

It is accordingly the object of the invention to provide an airfoil configuration that maximizes the aerodynamic efficiency of an aircraft wing. With the following objects in the views that are provided, in accordance with the invention, an airfoil configuration comprising:

a wing structure having a leading edge, a trailing edge, an upper surface extending from the leading edge to the trailing edge, and a lower surface extending from the leading edge to the trailing edge.

In accordance with a feature of the invention, an airfoil configuration comprising:

a wing structure having a leading or forward section which is stationary, and a trailing or rearward section which is movable.

The adjustable characteristic of the airfoil, in essence the wing, allows the wing to be configured for optimum efficiency for a given flight situation. The airfoil configuration could be selected with the aircraft in flight.

### BRIEF DESCRIPTION OF THE DRAWINGS

FIG. 1 Airfoil No. 1 defined in numerical values.

FIG. 2 Airfoil No. 1 changed to airfoil No. 3.

FIG. 3 Airfoils No. 2, No. 3, No. 4 with their respective surface area ratios.

FIG. 4 Airfoil No. 3 configuration at 80 percent of the rearward wing area.

### DETAILED DESCRIPTION OF THE INVENTION

The High Efficiency Airfoil

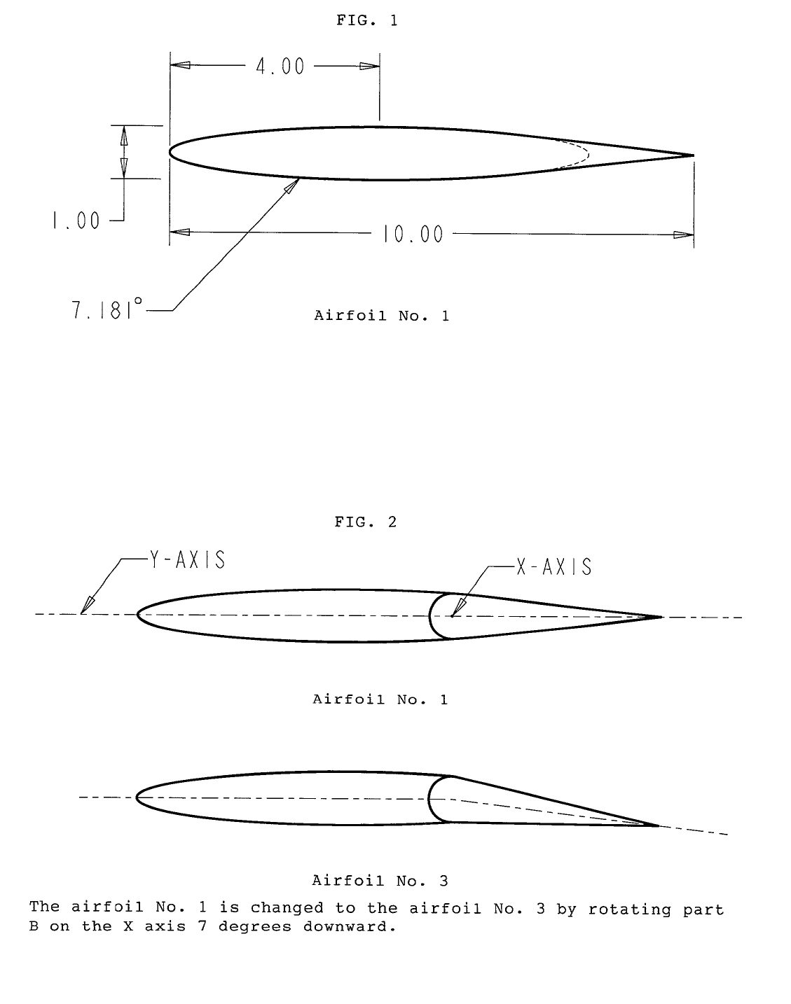

The high efficiency airfoil is symmetrical in shape and is the foundation for the variable airfoil wing. The airfoil is defined in FIG. 1. Modeled after proven airfoil shapes it allows for necessary structural integrity.

The Variable Airfoil Wing

The variable airfoil wing is divided into two segments, part A being the forward segment, part B being the rearward segment. Also established is axis X, running parallel to the wing span, and axis Y, running parallel to the wing chord. (FIG. 2) The airfoil No. 1 configuration is changed to the airfoil No. 3 configuration by rotating part B on the X axis 7 degrees downward.

The advantage of this type of wing is that it can be adjusted down for slow flight where high lift is needed, and adjusted up for fast flight to reduce drag. Devices such as wing leading edge and trailing edge flaps are used on some aircraft to achieve this goal of changing the wing camber. This invention is an extension of the same concept.

Certain parameters must be established to differentiate the said invention from aeronautical control surfaces such as a stabilizer or wing flaps.

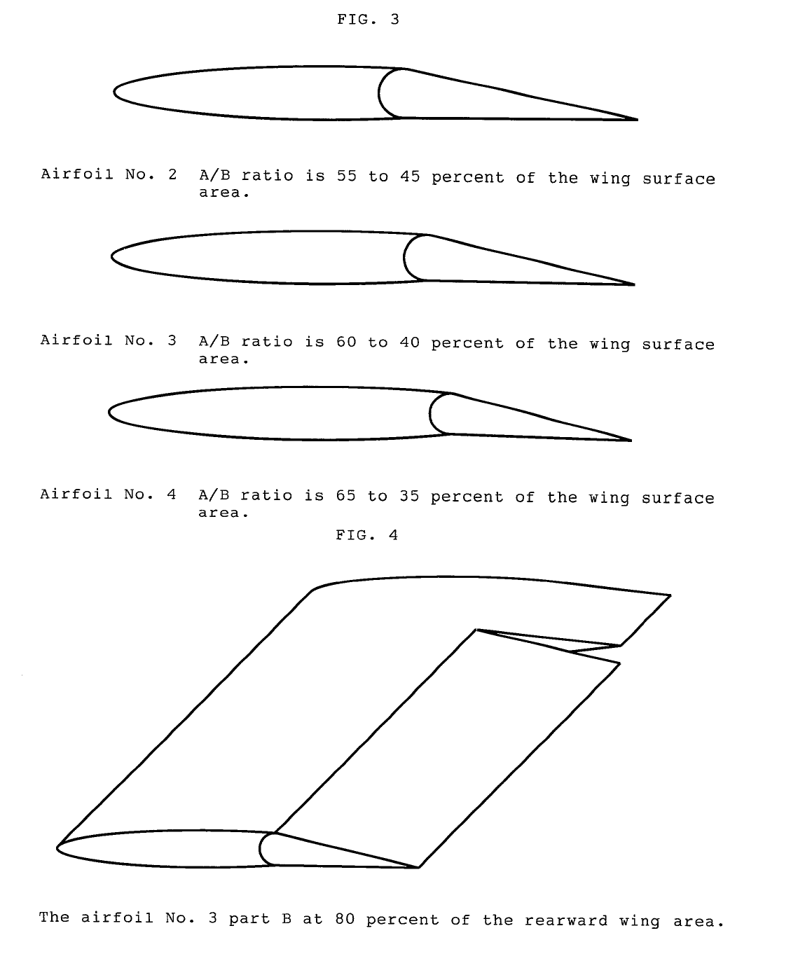

Any symmetrical functional airfoil shape may be used with the variable airfoil wing. The airfoil shape should be appropriate for the design application. In reference to the designated wing segments A and B, part A must be 55 to 65 percent of the wing surface chord length. Conversely, part B must be 45 to 35 percent of the wing surface chord length. (FIG. 3) Part A is stationary and structural in function. Part B deflection, rotating on the X axis, will always be 0 degrees up maximum on the Y axis. Part B deflection will always be no greater than 10 degrees down maximum. The The A/B segments would normally constitute 100 percent of their respective wing surface areas, however, part B may be reduced to no less than 80 percent of the rearward wing surface area. (FIG. 4)

An acceptable modification to the variable airfoil wing involves changing the A/B surface area ratio from a constant ratio to a graduated ratio. This graduated ratio may be positive or negative provided the A/B surface area ratio of 55/45 percent to 65/35 percent is maintained at the wing root. Such an application will in effect twist the Y axis of the wing airfoil.

In practical flight operation the variable airfoil wing would be adjusted slowly at a predetermined airspeed, similar to the use of wing flaps for takeoff and landing. Any mechanical control systems would be limited in speed and range of movement.

The construction of a variable airfoil wing could employ any of a number of flight certified materials such as wood, aluminum, or composite. Structural design would be that of an aerobatic category aircraft.

1. An airfoil design as illustrated in FIG. 1 and designated airfoil No. 1.

2. A symmetrical airfoil design divided into a forward segment, designated part A, and a rearward segment, designated part B. Part A is stationary, part B is movable. Specifically, part A will be 55 to 65 percent of the wing surface area. Conversely, part B will be 45 to 35 percent of the wing surface area. Part B movement will be from 0 to 10 degrees downward in the Y axis.

3. The utility value of the airfoil design is that by adjusting part B in a downward direction the wing camber is increased and the aerodynamic properties of the wing are significantly changed.
